(19) United States
(12) Patent Application Publication
(10) Pub. No.: US 2008/0030925 A1
(43) Pub. Date: Feb. 7, 2008

(54) Power connector

(75) Inventor: Wen-Chi Liu, Taoyuan Hsien (TW)

Correspondence Address: BIRCH STEWART KOLASCH & BIRCH, PO BOX 747, FALLS CHURCH, VA, 22040-0747, US

(73) Assignee: SPI ELECTRONIC CO., LTD.

(21) Appl. No.: 11/498,222

(22) Filed: Aug. 3, 2006

(51) Int. Cl. H01G 9/08

(52) U.S. Cl. 361/517

(57) ABSTRACT

The present invention discloses a power connector used as an electric conducting component between output terminals having an equal electric potential, so that the output terminals having an equal electric potential can share the same electric wire of the same electric potential, so as to save the material cost of wires.

### FIELD OF THE INVENTION

The present invention relates to a power connector, and more particularly to an electric conducting component installed between output terminals having an equal electric potential to reduce wire materials.

### BACKGROUND OF THE INVENTION

Due to the advancement of modern science and technology, electric appliances have become an indispensable part of our life, and regardless of food, clothing, housing, transportation, education and recreation, electronic appliances occupy a large proportion. Particularly, the demand for cables such as power wires, electric cables or signal lines of the electronic appliances exceeds several million tons every year in Taiwan, and the recycle of electric wires is less than one tenth of such quantity. Only a portion of the recycled electric wires (less than one tenth of the production) is recycled and reused, and thus waste electric wires become a secret worry to our environment if they are not handled properly. Since the material cost of electric wires is increasingly higher, the price of electric appliances also goes up and the high price becomes a tremendous burden to consumers and manufacturers.

Therefore, a flat cable that can save wire material is introduced to the market. For instance, a flat cable having several connectors as disclosed in R.O.C. Patent No. M272252 has a main body, and the main body has an external covering layer, and the external covering layer is covered by a plurality of parallel insulating signal lines. The main body has several sets of connector modules of different models and specifications, and each connector module includes a male connector and a female connector corresponding to two terminals of signal lines, and the male connector and female connector separately have a connecting portion, and the connecting portion has a plurality of terminal pins and terminal slots, and electric conducting terminals of the terminal pins and terminal slots are passed through an external covering layer of the main body and electrically coupled to the signal lines.

Although the foregoing flat cable having different connectors can save the wire material, most flat cables can be used in computers only and a very small portion of electric wires is used for electric appliances. Power wire is used extensively for the electric wire of electric appliances, and the power wire used for interconnecting a power supply and a computer (as shown in FIG. 1) still does not come with the related technology of saving wire materials. Further, each output terminal of a prior art power supply is connected to the power supply by a power wire regardless of the electric potential of the power supply being the same for adjacent output terminals or the output terminals having an equal electric potential. Therefore, the prior art not only wastes the wire material and wiring time of the power wire, but also creates a secret worry to our environment.

### SUMMARY OF THE INVENTION

A primary objective of the present invention is to overcome the foregoing shortcomings and avoid the existing deficiencies by providing a power connector that can be used for an electric conducting component between output terminals having an equal electric potential, so that the output terminals having an equal electric potential can share a power wire with the same electric potential, so as to save material cost and wiring time of the wire and enhance industrial competitiveness and achieve the purposes for environmental protection.

The present invention relates to a power connector applicable for connecting a set of power cables, and the set of power cables is divided into a plurality of power wires having different electric potentials, and the power connector comprises an insulating casing having a plurality of positioning slots and defining an end of the positioning slot as a power wire electrically coupled to the power input terminal and another end as a power output terminal; a plurality of power wires installed in the positioning slots and electrically coupled to output terminals of the power wires of the set of power cables; and at least one electric conducting component electrically coupled to the output terminal having an equal electric potential, such that one of the power wires is coupled separately to a plurality of output terminals by the electric conducting components, and the power output terminals output an equal electric potential, so as to effectively save the material of the power wires.

### BRIEF DESCRIPTION OF THE DRAWINGS

FIG. 1 is a perspective view of a prior art;

FIG. 2 is a perspective view of a first preferred embodiment of the present invention;

FIG. 3 is an exploded view of the first preferred embodiment of the present invention;

FIG. 4 is an exploded view of a second preferred embodiment of the present invention;

FIG. 5 is a schematic view of an electric potential of an output terminal in accordance with the second preferred embodiment of the present invention;

FIG. 6 is an exploded view of a third preferred embodiment of the present invention;

FIG. 7 is a schematic view of an electric potential of an output terminal in accordance with a fourth preferred embodiment of the present invention;

FIG. 8 is a perspective rear view of the fourth preferred embodiment of the present invention;

FIG. 9 is a schematic view of an electric potential of an output terminal in accordance with a fifth preferred embodiment of the present invention;

FIG. 10 is a perspective rear view of the fifth preferred embodiment of the present invention;

FIG. 11 is an exploded view of a sixth preferred embodiment of the present invention;

FIG. 12 is a schematic view of an output terminal of a seventh preferred embodiment of the present invention;

FIG. 13 is an exploded view of a portion of the seventh preferred embodiment of the present invention;

FIG. 14 is an exploded view of an eighth preferred embodiment of the present invention; and

FIG. 15 is a perspective view of the eighth preferred embodiment of the present invention.

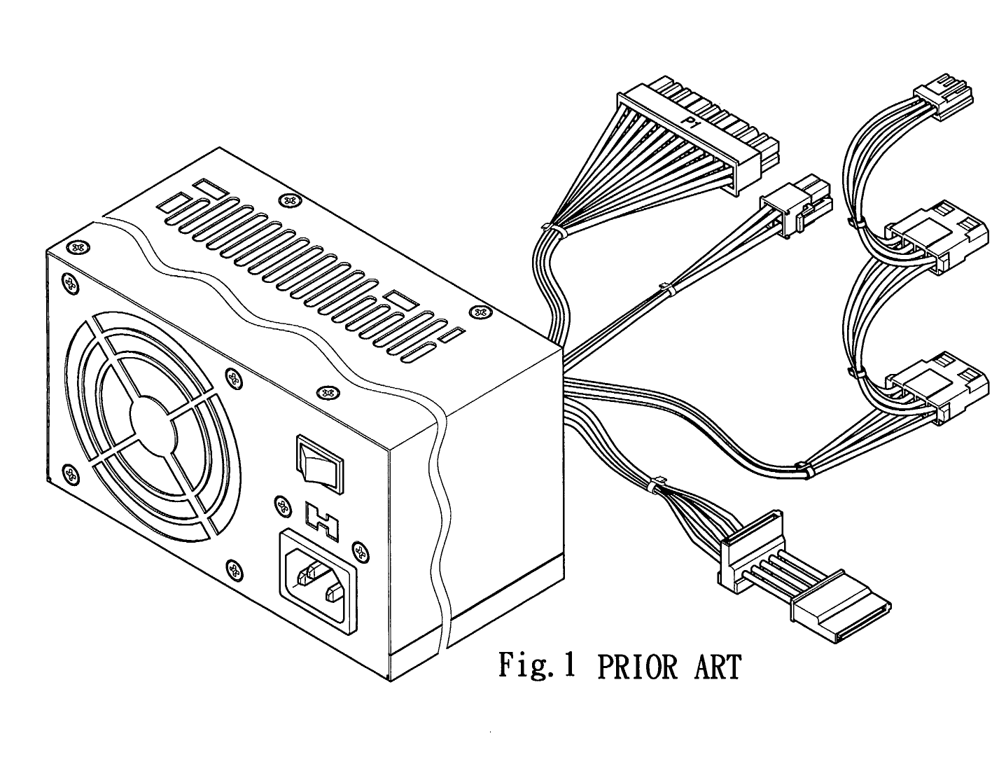

### DETAILED DESCRIPTION OF THE PREFERRED EMBODIMENTS

To make it easier for our examiner to understand the technical characteristics, objective and performance of the invention, we use a preferred embodiment together with the attached drawings for the detailed description of the invention.

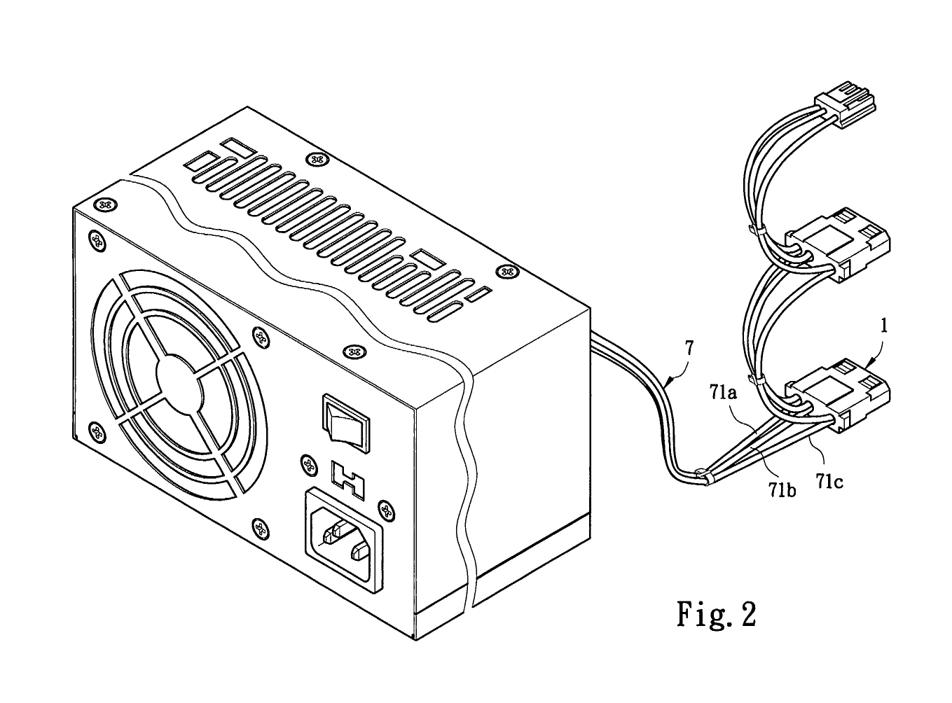

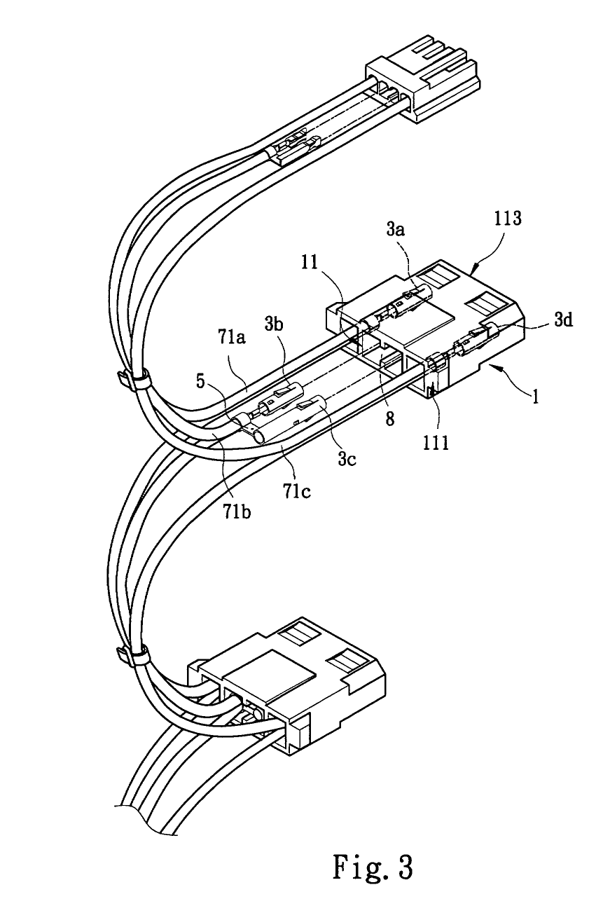

Referring to FIGS. 2 and 3 for a perspective view and an exploded view of a first preferred embodiment of the present invention respectively, the present invention provides a power connector, and the power connector is a 4-pin periphery power connector in this embodiment, and the power connector is applicable for connecting a set of power cables 7, and the power cables 7 are divided into several different power wires 71a, 71b, 71c having different electric potentials, wherein the power wire 71a has a 12V potential, the power wire 71b has a zero reference potential (COM), and the power wire 71c has a 5V potential. The power connector includes a hollow insulating casing 1, a plurality of output terminals 3a, 3b, 3c, 3d contained into the insulating casing 1 and electrically coupled to the power wire 71a, 71b, 71c; and an electric conducting component 5 electrically coupled to output terminals having an equal electric potential 3b, 3c.

The insulating casing 1 includes a plurality of positioning slots 11 therein, and defines an end of the positioning slot 11 as a power input terminal 111 electrically coupled to the power wire 71a, 71b, 71c.

The output terminals 3a, 3b, 3d are installed in the positioning slot 11, wherein the output terminals 3a, 3b, 3d are electrically coupled to the power input terminal 111 along the directions of the power wires 71a, 71b, 71c respectively, and coupled to an external electric appliance in the direction of the power output terminal 113.

The electric conducting component 5 electrically coupled to output terminals having an equal electric potential 3b, 3c are preferably made of a metal material, wherein the foregoing electric conducting component 5 can be electrically coupled to the output terminals 3b, 3c by means of an integral punching method or a hole-for-insertion method. In this embodiment, the electric conducting component 5 is electrically coupled to the output terminals 3b, 3c by an integral punching method for containing an electric conducting component 5 by a guiding slot 8, wherein the guiding slot 8 is interconnected to two positioning slots 11 of the output terminals with an equal electric potential 3b, 3c by the hole-for-insertion method. By the foregoing electrically coupled electric conducting component 5, the output terminals 3b, 3c have an equal electric potential, so that the power wire 71b can use the electric conducting component 5 to divide the electric connection of the output terminals 3b, 3c, so as to output electric power with an equal electric potential and save one of the original two power wires having the same electric potential. The present invention can effectively save the material of power wire.

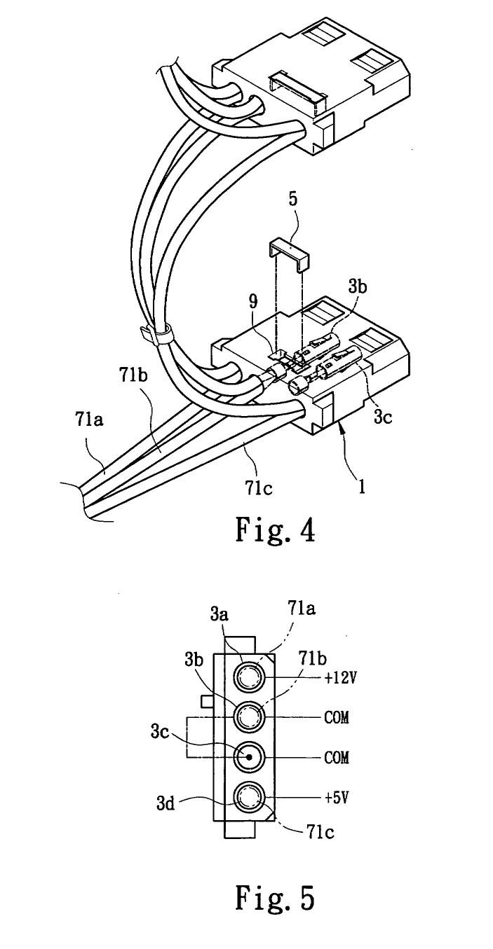

Referring to FIGS. 4 and 5 for an exploded view of a portion of a second preferred embodiment of the present invention and a schematic view of the electric potential of an output terminal of a second preferred embodiment of the present invention respectively, the difference between the second preferred embodiment from the first preferred embodiment resides on its using a guiding hole 9 to pass and electrically connect the electric conducting component 5 to the output terminals 3b, 3c having an equal electric potential.

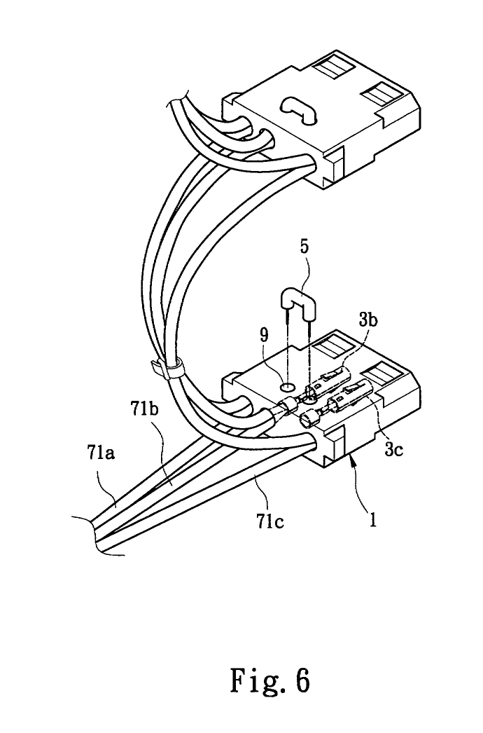

Referring to FIG. 6 for an exploded view of a portion of a third preferred embodiment of the present invention, the difference of the third preferred embodiment from the first preferred embodiment of the present invention resides on its using a conducting wire to replace the electric conducting plate for an electric conducting component 5.

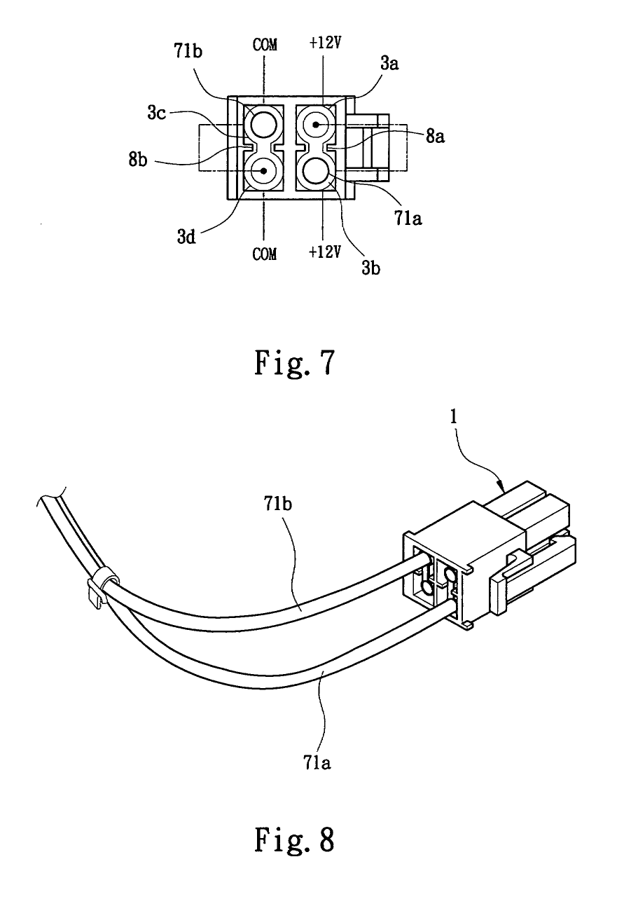

Referring to FIGS. 7 and 8 for a schematic view of the electric potential of an output terminal of a fourth preferred embodiment of the present invention and a perspective rear view of a fourth preferred embodiment of the present invention respectively, the power connector of this embodiment is a 12V 4-pin power connector. Similar to the first preferred embodiment that uses a hole disposed on a side, two output terminals 3a, 3b having a 12V potential are used to electrically conduct a first power wire 71a having a 12V potential by an electric conducting component disposed in the guiding slot 8a, such that two output terminals 3c, 3d having a zero potential (COM) are used to electrically conduct a second power wire 71b having a 12V potential by another electric conducting component disposed in the guiding slot 8b.

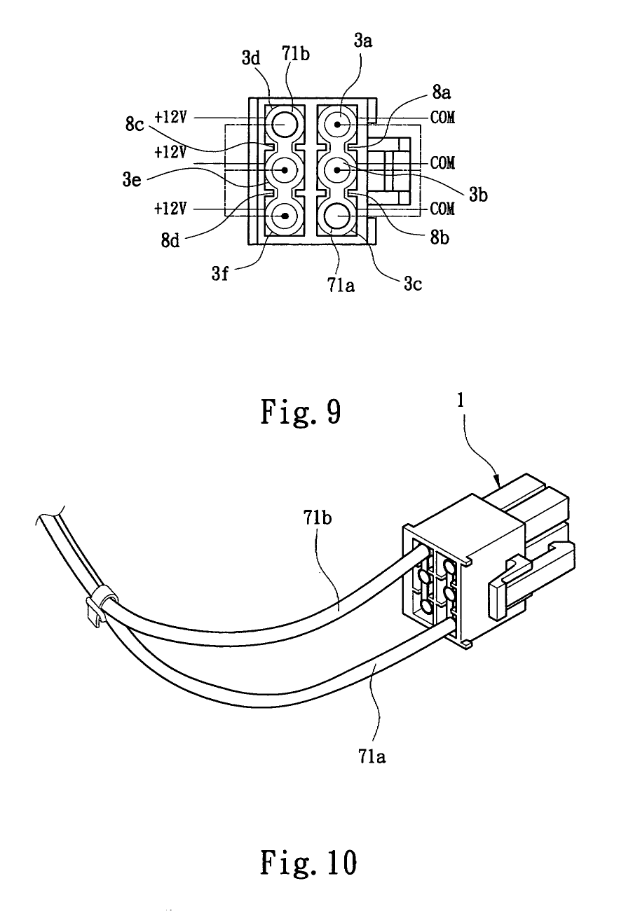

Referring to FIGS. 9 and 10 for a schematic view of the electric potential of output terminal of a fifth preferred embodiment of the present invention and a perspective rear view of the fifth preferred embodiment of the present invention respectively, the power connector of this embodiment is a 6-pin PCI-E power connector, and this embodiment uses the same method of having a hole on a side as the first preferred embodiment, such that three output terminals 3a, 3b, 3c having a zero reference potential (COM) are conducted electrically to a first power wire 71a having a 12V potential by two electric conducting component having a 12V potential and disposed in two guiding slots 8a, 8b along the same axis, and three output terminals 3d, 3e, 3f having a 12V potential is conducted electrically to a second power wire 71b having a 12V potential by another two electric conducting components disposed in the two guiding slots 8c, 8d along the same axis.

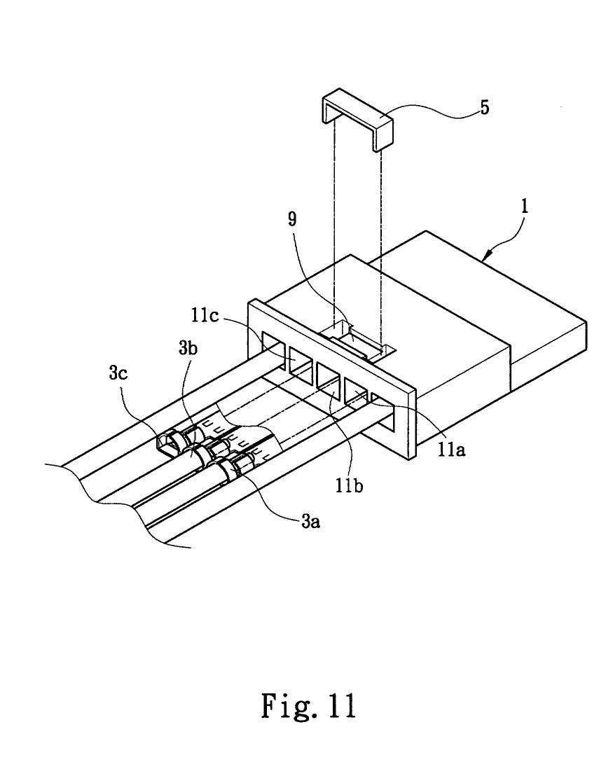

Referring to FIG. 11 for an exploded view of a sixth preferred embodiment of the present invention, the power connector of this embodiment is a 15-pin Serial ATA power connector. Similar to the second preferred embodiment that adopts a hole-for-insertion method, two output terminals 3a, 3c having a zero reference potential (COM) are electrically conducted by passing the electric conducting component 5 through the guiding hole 9, wherein the guiding hole 9 is disposed across the positioning slot 11b to interconnect the positioning slot 11a and the positioning slot 11c, so as to set the output terminal 3b across to constitute an equal electric potential for the output terminal 3a and the output terminal 3c.

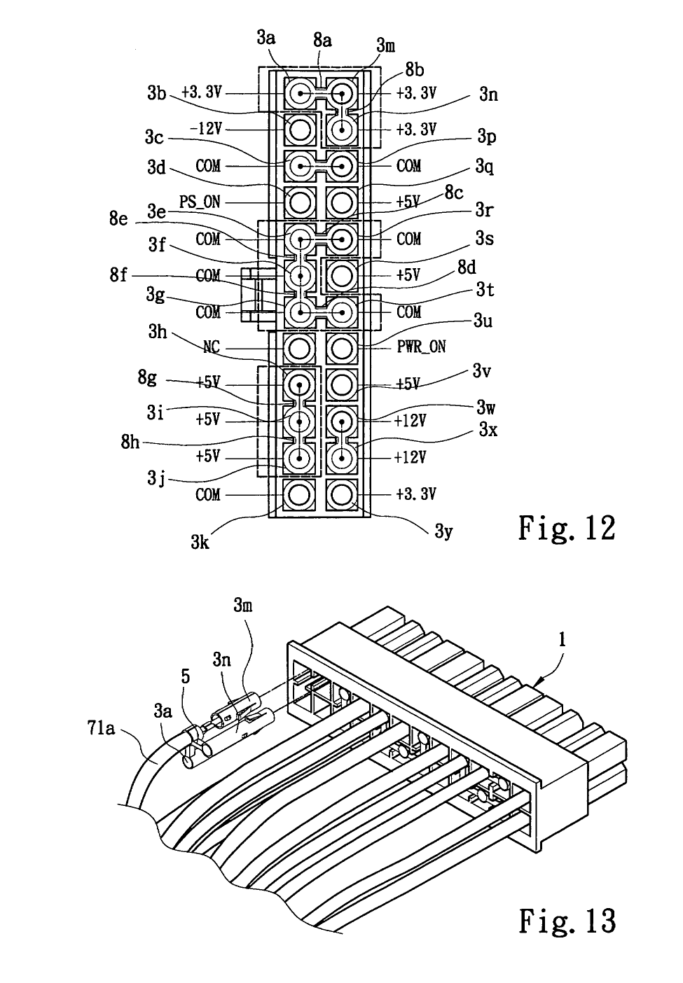

Referring to FIGS. 12 and 13 for a schematic view of the electric potential of an output terminal of a seventh preferred embodiment of the present invention and an exploded view of a portion of the seventh preferred embodiment of the present invention respectively, the power connector of this embodiment is an 24-pin integrated ATX main power connector. Similar to the first preferred embodiment that adopts a hole-for-insertion on a side, the output terminal having an equal electric potential and adjacent to the hole this embodiment can be conducted electrically, wherein the output terminals 3d, 3u are signal lines for transmitting signals from a power output terminal 113 to a power input terminal 111. It is noteworthy that the output terminals 3a, 3m, 3n are contained in three positioning slots distributed in an L-shape, and a guiding slot 8a, 8b is disposed separately along the horizontal axis and a vertical axis between the foregoing three positioning slots. The output terminals 3e, 3f, 3r, 3s, 3t having a zero reference potential (COM) are contained in five positioning slots distributed in a U-shape, and two parallel guiding slots 8c, 8d are disposed along the horizontal axis between the five positioning slots, and another two guiding slots 8e, 8f are disposed along the same axis between the two parallel guiding slots. Further, the output terminals 3h, 3i, 3j having a 5V potential are contained in three positioning slots in the same axis and two guiding slots 8g, 8h are disposed among the three positioning slots.

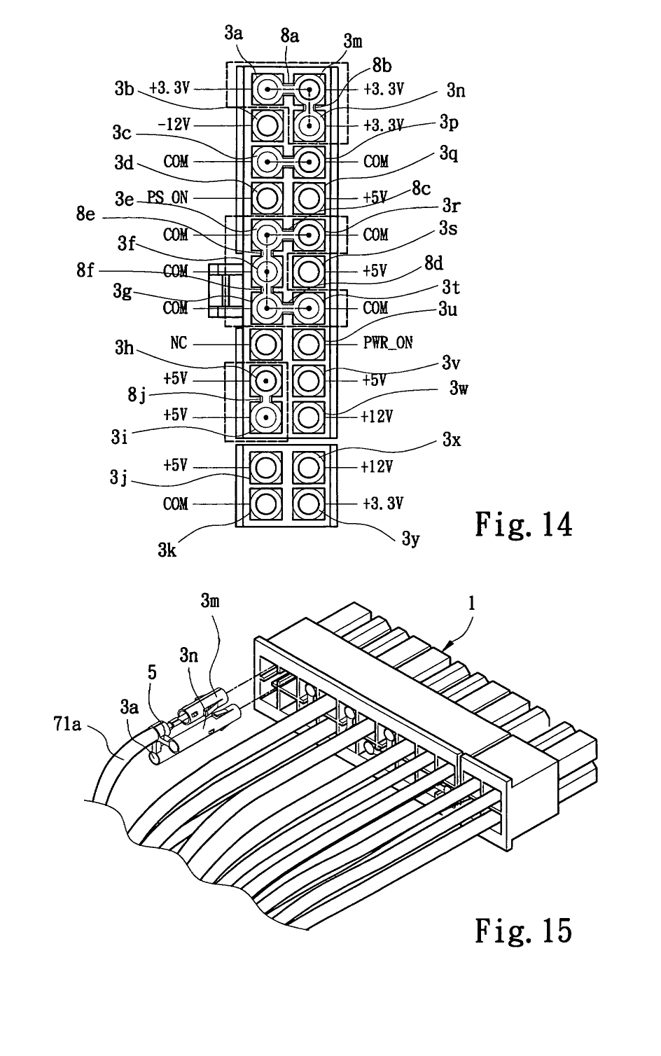

Referring to FIGS. 14 and 15 for an exploded view and a perspective view of an eighth preferred embodiment of the invention respectively, the power connector of this embodiment is a separate connecting 20pin+4Pin ATX main power connector. Unlike the sixth preferred embodiment, the output terminals 3h, 3i having a 5V potential of this embodiment are contained in two positioning slots, and only one guiding slot 8j is disposed between two positioning slots, and the output terminals 3w, 3x are not conducted electrically.

In summation of the description above, the power connector of the invention uses at least one electric conducting component to pass through a guiding slot or a guiding hole, so that the output terminals having an equal electric potential can be conducted electrically, and one of the power wires can use the electric conducting component to divide the electric power to be connected to several output terminals, and the power output terminal can output electric power having an equal electric potential. Therefore, the invention can save the material of power wires and complies with the requirements of patent applications.

While the invention has been described by means of specific embodiments, numerous modifications and variations could be made thereto by those skilled in the art without departing from the scope and spirit of the invention set forth in the claims.

What is claimed is:

1. A power connector, applicable for connecting a set of power cables, and said set of power cables being divided into a plurality of power wires having different electric potentials, and said power connector comprising:
an insulating casing, having a plurality of positioning slots, and defining an end of said positioning slot as a power wire electrically coupled to said power input terminal and another end as a power output terminal;
a plurality of power wires, installed in said positioning slots and electrically coupled to output terminals of said power wires of said set of power cables; and
at least one electric conducting component, electrically coupled to said output terminal having an equal electric potential, such that one of said power wires is coupled separately to a plurality of output terminals by said electric conducting components, and said power output terminals output an equal electric potential, so as to effectively save the material of said power wires.

2. The power connector of claim 1, wherein said positioning slots have at least one guiding slot for containing said electric conducting component.

3. The power connector of claim 1, wherein said positioning slots are distributed adjacent with each other in an L-shape and having at least one guiding slot disposed separately along a first axis and a second axis.

4. The power connector of claim 3, wherein said positioning slots are three positioning slots distributed in an L-shape.

5. The power connector of claim 1, wherein said positioning slots are distributed adjacent with each other in a U-shape and having two parallel guiding slots along an axis and at least one guiding slot disposed between said two parallel guiding slots along the same axis.

6. The power connector of claim 5, wherein said positioning slots are five positioning slots distributed in a U-shape.

7. The power connector of claim 1, wherein said insulating casing has at least one guiding hole, such that said electric conducting component is passed through said guiding hole and coupled to said output terminal having an equal electric potential.

8. The power connector of claim 1, wherein said electric conducting component is disposed between two adjacent output terminals in said positioning slots.

9. The power connector of claim 1, wherein said electric conducting component is a conducting wire.

10. The power connector of claim 1, wherein said electric conducting component is an electric conducting plate.

11. A power connector, applicable for connecting a set of power cables, and said set of power cables being divided into a plurality of power wires having different electric potentials, and said power connector comprising:
an insulating casing, having a plurality of positioning slots, and defining an end of said positioning slot as a power wire electrically coupled to said power input terminal and another end as a power output terminal;
a plurality of output terminals, installed in said positioning slots and electrically coupled to output terminals of said power wires; and
at least one electric conducting component, electrically coupled to output terminals having an equal electric potential.

12. The power connector of claim 11, wherein said set of power cables includes at least one signal wire electrically coupled to said output terminal, for transmitting an electric communication signal in a direction from said power output terminal of said output terminal to said power input terminal of said output terminal.

13. The power connector of claim 11, wherein said positioning slots include at least one guiding slot for containing said electric conducting component.

14. The power connector of claim 11, wherein said positioning slots are distributed in an L-shape and having at least one guiding slot separately along a first axis and a second axis.

15. The power connector of claim 14, wherein said positioning slots are three positioning slots distributed in an L-shape.

16. The power connector of claim 11, wherein said positioning slots are distributed in a U-shape and having two parallel guiding slots along an axis and at least one guiding slot disposed between said two parallel guiding slots along the same axis.

17. The power connector of claim 16, wherein said positioning slots are five positioning slots distributed in a U-shape.

18. The power connector of claim 11, wherein said insulating casing includes at least one guiding hole, such that said electric conducting component is passed through said guiding hole and connected to said output terminals having an equal electric potential.

19. The power connector of claim 11, wherein said electric conducting components are installed between two adjacent output terminals in said positioning slots.

20. The power connector of claim 11, wherein said electric conducting component is a conducting wire.

21. The power connector of claim 11, wherein said electric conducting component is an electric conducting plate.
